(19) United States
(12) Patent Application Publication
(10) Pub. No.: US 2024/0403659 A1
(43) Pub. Date: Dec. 5, 2024

(54) SECURE GROUPING APPARATUS, SECURE GROUPING METHOD, AND PROGRAM

(71) Applicant: NIPPON TELEGRAPH AND TELEPHONE CORPORATION, Tokyo (JP)

(72) Inventor: Koki HAMADA, Tokyo (JP)

(21) Appl. No.: 18/696,010

(22) PCT Filed: Oct. 15, 2021
(86) PCT No.: PCT/JP2021/038294

§ 371 Date: Mar. 27, 2024

(51) Int. Cl. G06N 5/01; G06F 17/16

(52) U.S. Cl. CPC G06N 5/01; G06F 17/16

(57) ABSTRACT

A secure grouping apparatus according to an embodiment is a secure grouping apparatus that is given training data including a plurality of samples having m explanatory variables as a hidden value of an objective variable vector z having a value of an objective variable of each sample as an element and an explanatory variable vector wⱼ (j∈[1, m]) having a value of a j-th explanatory variable of each sample as an element, groups the samples included in the training data into groups, and executes grouping to arrange samples in the same group to be continuous in secure calculation, the secure grouping apparatus including an input unit that inputs a hidden value of an objective variable vector y of the grouped training data, a hidden value of a permutation σⱼ for stably sorting a j-th explanatory variable vector of the grouped training data in a group, a hidden value of an explanatory variable vector vⱼ obtained by stably sorting the j-th explanatory variable vector of the grouped training data in the group, and a hidden value of a grouping result vector b representing a grouping result when the training data is grouped into groups under a predetermined condition; and a secure grouping unit that calculates, in secure calculation, a hidden value of an objective variable vector y′ of the training data newly grouped according to a grouping result represented by the grouping result vector, a hidden value of a permutation σⱼ′ for stably sorting the j-th explanatory variable vector of the training data newly grouped according to the grouping result in a group, and a hidden value of an explanatory variable vector vⱼ′ obtained by stably sorting the j-th explanatory variable vector of the training data newly grouped according to the grouping result in a group.

### TECHNICAL FIELD

The present invention relates to a secret division device (secure grouping apparatus), a secret division method (secure grouping apparatus), and a program.

### BACKGROUND ART

As a method for obtaining a specific calculation result without restoring an encrypted numerical value, a method called secret calculation (secure calculation) (or hidden calculation) is known (for example, Non Patent Literature 1). In the method described in Non Patent Literature 1, encryption of distributing fragments of numerical values to three secret calculation devices is performed, and the three secret calculation devices perform cooperative calculation, and thus the results of addition/subtraction, constant addition, multiplication, constant multiplication, logical operation (NOT, logical product, logical sum, exclusive logical sum), data format conversion (integer and binary number), and the like can be obtained in a state of being distributed to the three secret calculation devices without restoring the numerical values.

Here, in a case where learning of a decision tree is performed by secret calculation, learning is generally performed while recursively dividing given training data (that is, learning is performed while recursively repeating further grouping of grouped training data).

For example, it is assumed that training data including n samples with an explanatory variable having m attributes (m≥1) is given as a vector z of an objective variable having a size n and a vector wⱼ(j∈[1, m]) of m explanatory variables having a size n. Furthermore, the elements of the vector z and the elements of the vectors wⱼ that are rearranged while maintaining the correspondence relationship between the objective variable and the explanatory variables such that the samples of the training data are grouped and the samples of the same group are continuous are defined as vectors y and xⱼ, respectively. That is, if a certain permutation π of a magnitude n exists, y[π(i)]=z[i] for all i∈[1, n], and xⱼ[π(i)]=wⱼ[i] for all j∈[1, m], and if the i-th sample and the j-th sample (where i<j) after rearrangement are the same group, the k-th sample is also the same group for any k∈[i, j]. Note that y[i], z[i], xⱼ[i], and wⱼ[i] represent the i-th elements of the vectors y, z, xⱼ, and wⱼ, respectively.

At this time, in the learning of the decision tree by secret calculation, calculation of the vector y′, the vector vⱼ′, and the permutation σⱼ′ is repeatedly performed using the vector y, the vector vⱼ, the permutation σⱼ, and the vector b as inputs. Here, vⱼ is a vector in which the elements of xⱼ are rearranged in ascending order in the group, σⱼ is a permutation in which the elements of xⱼ are rearranged into vⱼ, and b is a vector representing a division result when each sample is divided into groups under a certain condition. In addition, y′ and xⱼ′ are vectors obtained by rearranging the elements of z and wⱼ while maintaining the correspondence relationship between the objective variable and each explanatory variable such that samples of the same group are adjacent by new grouping after further dividing each group into groups according to b, vⱼ′ is a vector obtained by rearranging the elements of xⱼ′ in ascending order in the group, and σⱼ′ is permutation in which the elements of xⱼ′ are rearranged into vⱼ′.

In addition, when the vector y′, the vector vⱼ′, and the permutation σⱼ′ are calculated, a method is used in which the vector xⱼ is calculated, the elements of the vector y and the elements of the vector xⱼ are rearranged into a new group according to the vector b to obtain the vectors y′ and xⱼ′, then the elements of the vector xⱼ′ are sorted in each group to obtain the permutation σⱼ′, and the elements of the vector xⱼ′ are rearranged according to the permutation σⱼ′ to obtain the vector vⱼ′.

### CITATION LIST

### Non Patent Literature

Non Patent Literature 1: Koji Chida, Koki Hamada, Dai Igarashi, Katsumi Takahashi, “A Three-Party Secure Function Evaluation with Lightweight Verifiability Revisited”. In CSS, 2010.

### SUMMARY OF INVENTION

### Technical Problem

However, in the above-described conventional method, it is necessary to sort the elements of the vector xⱼ′ when calculating the permutation σⱼ′, and thus, there is a problem that the calculation cost becomes higher.

An embodiment of the present invention has been made in view of the above points, and an object thereof is to reduce calculation costs in a case where data grouped by secret calculation is further grouped.

### Solution to Problem

To achieve the above-described object, a secure grouping apparatus (secret division device) according to an embodiment is a secure grouping apparatus that is given training data including a plurality of samples having m explanatory variables as a hidden value of an objective variable vector z having a value of an objective variable of each sample as an element and an explanatory variable vector wⱼ (j∈[1, m]) having a value of a j-th explanatory variable of each sample as an element, groups the samples included in the training data into groups, and executes grouping to arrange samples in the same group to be continuous in secure calculation, the secure grouping apparatus including an input unit that inputs a hidden value of an objective variable vector y of the grouped training data, a hidden value of a permutation σⱼ for stably sorting a j-th explanatory variable vector of the grouped training data in a group, a hidden value of an explanatory variable vector vⱼ obtained by stably sorting the j-th explanatory variable vector of the grouped training data in the group, and a hidden value of a grouping result vector b representing a grouping result when the training data is grouped into groups under a predetermined condition; and a secure grouping unit that calculates, in secure calculation, a hidden value of an objective variable vector y′ of the training data newly grouped according to a grouping result represented by the grouping result vector, a hidden value of a permutation σⱼ′ for stably sorting the j-th explanatory variable vector of the training data newly grouped according to the grouping result in a group, and a hidden value of an explanatory variable vector vⱼ′ obtained by stably sorting the j-th explanatory variable vector of the training data newly grouped according to the grouping result in a group.

### Advantageous Effects of Invention

It is possible to reduce calculation costs when the data grouped by secret calculation is further grouped.

### BRIEF DESCRIPTION OF DRAWINGS

FIG. 1 is a diagram illustrating an example of a hardware configuration of a secret division device according to the present embodiment.

FIG. 2 is a diagram illustrating an example of a functional configuration of the secret division device according to the present embodiment.

FIG. 3 is a flowchart showing an example of a flow of a secret division process according to an embodiment.

### DESCRIPTION OF EMBODIMENTS

Hereinafter, an embodiment of the present invention will be described. In the present embodiment, a description will be given about a secret division device 10 (secure grouping apparatus) capable of reducing calculation costs required when data grouped by secret calculation (secure calculation) is further grouped.

### Notation, Definitions, Etc.

Hereinafter, notation, definitions, and the like used in the present embodiment will be described.

A value obtained by hiding a value a in encryption, secret sharing, or the like is referred to as a hidden value of a, and is denoted as [[a]]. In a case where a is hidden by secret sharing, a set of fragments of the secret sharing of each secret calculation device is referred to in [[a] ].

The i-th element of the vector v is referred to by v[i]. That is, when the vector v has a size n, v=(v[1], v[2], . . . , v[n]).

A permutation having a size n is a bijection of {1, 2, . . . , n}→{1, 2, . . . , n}, and when the permutation α of a size n satisfies α(i)=bᵢ for each i∈[1, . . . , n], the permutation is expressed as follows.

$$α = ( \begin{matrix}1 & 2 & … & n \\ {b}_{1} & {b}_{2} & … & {b}_{n}\end{matrix} ) \qquad [ Math . 1 ]$$

An operation of creating a vector v′ in which elements of the vector v having the size n are rearranged such that v′[α(i)]=v[i] by the permutation α of the size n is referred to as “application”, and is denoted by v′=αv. In addition, in the following description, as long as no confusion occurs, rearranging the elements of the vector v may be simply described as “rearranging the vectors v” or the like.

A permutation ρ of the size n that satisfies ρ(i)=π(σ(i)) for the permutation π, σ of the size n and each i∈[1, n] is called synthesis of the permutation π and the permutation σ, and is expressed as follows.

$$ρ = π ∘ σ \qquad [ Math . 2 ]$$

The inverse mapping of the permutation π is referred to as an inverse permutation and expressed as π⁻¹.

### <Hardware Configuration of Secret Division Device 10>

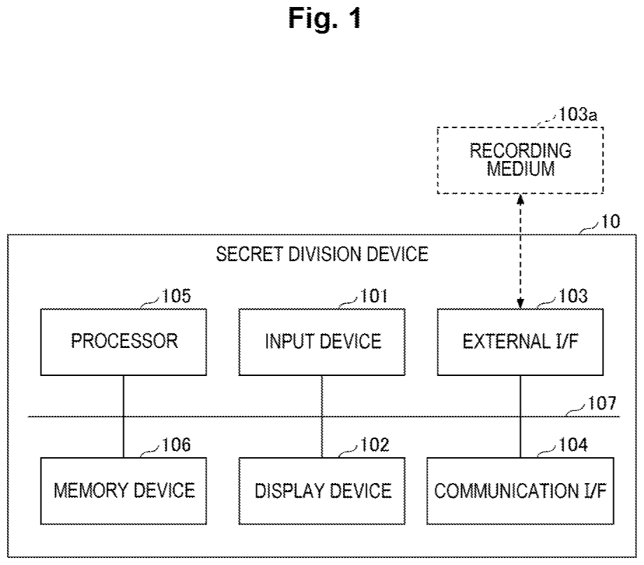

FIG. 1 illustrates a hardware configuration of the secret division device 10 according to the present embodiment. As illustrated in FIG. 1, the secret division device 10 according to the present embodiment is realized by a hardware configuration of a general computer or a computer system, and includes an input device 101, a display device 102, an external I/F 103, a communication I/F 104, a processor 105, and a memory device 106. These hardware units are communicatively connected via a bus 107.

Examples of the input device 101 include a keyboard, a mouse, a touch panel, a physical button, and the like. The display device 102 is, for example, a display, a display panel, or the like. Note that the secret division device 10 may not include, for example, at least one of the input device 101 and the display device 102.

The external I/F 103 is an interface with an external device such as a recording medium 103a. The secret division device 10 can perform reading and writing in the recording medium 103a via the external I/F 103. Note that the recording medium 103a includes, for example, a compact disc (CD), a digital versatile disk (DVD), a secure digital memory card (SD memory card), a universal serial bus (USB) memory card, and the like.

The communication I/F 104 is an interface for connecting the secret division device 10 to a communication network. The processor 105 is, for example, any of various arithmetic devices such as a central processing unit (CPU) and a graphics processing unit (GPU). The memory device 106 is, for example, any of various storage devices such as a hard disk drive (HDD), a solid state drive (SSD), a random access memory (RAM), a read only memory (ROM), and a flash memory.

The secret division device 10 according to the present embodiment has the hardware configuration illustrated in FIG. 1, and thus it is possible to realize the secret division process to be described below. Note that the hardware configuration illustrated in FIG. 1 is an example, and the secret division device 10 may have another hardware configuration. For example, the secret division device 10 may include a plurality of processors 105 and a plurality of memory devices 106.

### <Functional Configuration of Secret Division Device 10>

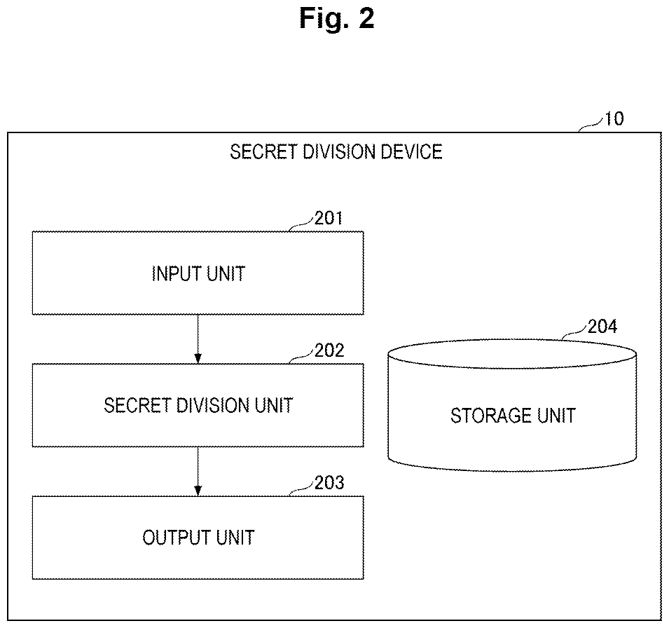

FIG. 2 illustrates a functional configuration of the secret division device 10 according to the present embodiment. As illustrated in FIG. 2, the secret division device 10 according to the present embodiment includes an input unit 201, a secret division unit 202, and an output unit 203. Each of these units is realized, for example, by one or more programs installed in the secret division device 10 causing the processor 105 to execute a process. Furthermore, the secret division device 10 according to the present embodiment includes a storage unit 204. The storage unit 204 is realized by, for example, the memory device 106.

The input unit 201 inputs a hidden value of grouped data. The secret division unit 202 calculates a hidden value of data obtained by further grouping hidden values input by the input unit 201 in secret calculation. The output unit 203 outputs the hidden value calculated by the secret division unit 202. The storage unit 204 stores data such as a hidden value input by the input unit 201, a hidden value output by the output unit 203, and a hidden value of a calculation result (including an intermediate calculation result) of the secret division unit 202.

### EXAMPLE

An example is described below. Hereinafter, although it is assumed that all the data including input, output, and intermediate calculation results with respect to the secret division device 10 are hidden values, the description of “the hidden value of” may be omitted in some cases. For example, the hidden value [[π]] of the permutation π may be expressed as “permutation [[π]]”.

In addition, the number of attributes of the explanatory variable is m≥1, and j∈[1, m]. Furthermore, some processes are defined below.

It is assumed that [[π]]←StableSort ([[x]]) represents a process of calculating the hidden value [[π]] of the permutation π that stably sorts the vector x from the hidden value [[x]] of the vector x. Note that it is assumed that sorting means rearrangement in ascending order.

It is assumed that [[y]]←Apply ([[π]], [[x]]) represents a process of calculating the hidden value [[y]] of the vector y=πx from the hidden value [[x]] of the vector x and the hidden value [[π]] of the permutation r.

It is assumed that [[σ]]←[[π]]⁻¹ represents a process of calculating the hidden value [[σ]] of the permutation σ=π⁻¹ from the hidden value [[π]] of the permutation π.

$$[ [ ρ ] ] ← [ [ π ] ] ∘ [ [ σ ] ] \qquad [ Math . 3 ]$$

It is assumed that the above expression represents a process in which the hidden value [[π]] of the permutation π and the hidden value [[σ]] of the permutation σ are used to calculate the hidden value [[ρ]] of the permutation expressed by the following expression.

$$ρ = π ∘ σ \qquad [ Math . 4 ]$$

In the present example, it is assumed that training data including n samples with an explanatory variable having m attributes (m≥1) is given to the secret division device 10 as a vector z of an objective variable having a size n and a vector wⱼ (j∈[1, m]) of m explanatory variables having a size n. Furthermore, the elements of the vector z and the elements of the vectors wⱼ that are rearranged while maintaining the correspondence relationship between the objective variable and the explanatory variables such that the samples of the training data are grouped and the samples of the same group are continuous are defined as vectors y and xⱼ, respectively. That is, if a certain permutation π of a magnitude n exists, y[π(i)]=z[i] for all i∈[1, n], and xⱼ[π(i)]=wⱼ[i] for all j∈[1, m], and if the i-th sample and the j-th sample (where i<j) after rearrangement are the same group, the k-th sample is also the same group for any k∈[i, j].

At this time, the secret division device 10 according to the present example performs calculating by receiving the vector y, the vector vⱼ, the permutation σⱼ, and the vector b and performing secret calculation of the vector y′, the vector vⱼ′, and the permutation σⱼ′ (that is, performing calculation while hiding the values of input and output and the intermediate calculation results), and performs the secret division process of output the calculation results. However, vⱼ is a vector in which the elements of xⱼ are rearranged in ascending order in the group, σⱼ is a permutation in which the elements of x: are rearranged into vⱼ, and b is a vector representing a division result when each sample is divided into groups under a certain condition. In addition, y′ and xⱼ′ are vectors obtained by rearranging the elements of z and wⱼ while maintaining the correspondence relationship between the objective variable and each explanatory variable such that samples of the same group are adjacent by new grouping after further dividing each group into groups according to b, vⱼ′ is a vector obtained by rearranging the elements of xⱼ′ in ascending order in the group, and σⱼ′ is permutation in which the elements of xⱼ′ are rearranged into vⱼ′.

That is, the input and output of the secret division process executed by the secret division device 10 according to the present example are as follows.

Input: the vector [[y]] of the grouped objective variables, the permutation [[σⱼ]] for stably sorting the grouped explanatory variables in the group, the vector [[vⱼ]] obtained by stably sorting the grouped explanatory variables in the group, and the vector [[b]] representing a division result

Output: the vector [[y′]] of the objective variables newly grouped according to the division result, the permutation [[σⱼ′]] for stably sorting the explanatory variables newly grouped according to the division result in the group, and the vector [[vⱼ′]] obtained by stably sorting the explanatory variables newly grouped according to the division result in the group

By repeatedly performing the secret division process having the input and output, the decision tree can be learned from secret calculation.

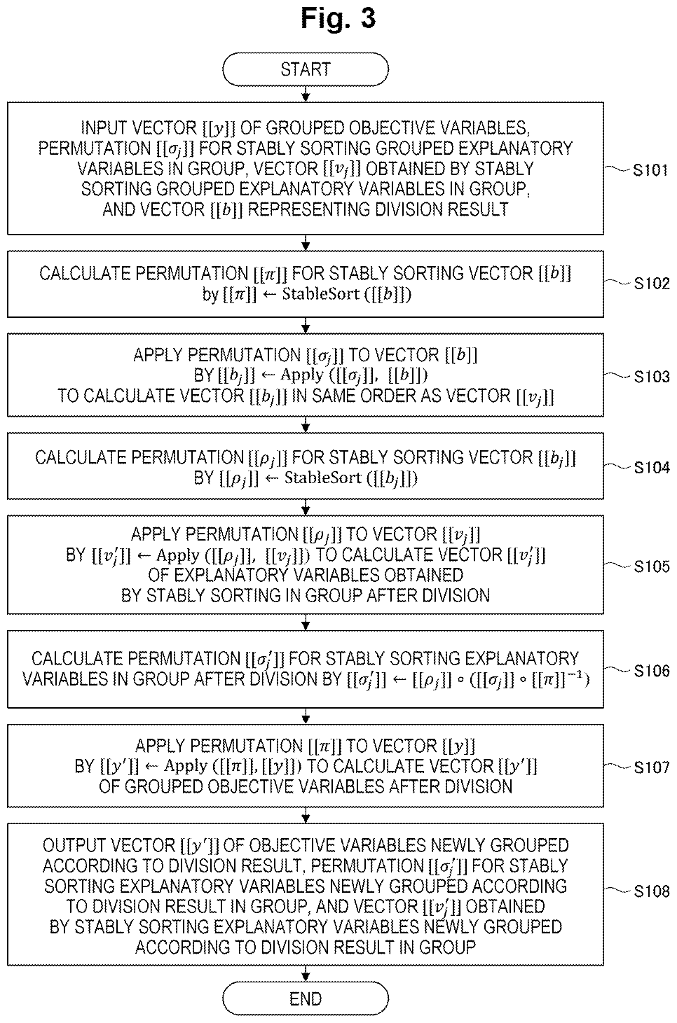

The secret division process according to the present example will be described below with reference to FIG. 3.

Step S101: The input unit 201 inputs the vector [[y]] of the grouped objective variables, the permutation [[σⱼ]] for stably sorting the grouped explanatory variables in the group, the vector [[vⱼ]] obtained by stably sorting the grouped explanatory variables in the group, and the vector [[b]] representing a division result.

Step S102: The secret division unit 202 calculates the permutation [[π]] for stably sorting the vector [[b]] representing the division result by [[π]]←StableSort ([[b]]).

Step S103: The secret division unit 202 applies the permutation [σⱼ] for stably sorting the grouped explanatory variables in the group to the vector [[b]] by [[bⱼ]]←Apply ([[σⱼ]], [[b]]) to calculate a vector [[bⱼ]] in which the grouped explanatory variables are arranged in the same order as the vector [[vⱼ]] obtained by stably sorting the grouped explanatory variables in the group.

Step S104: The secret division unit 202 calculates the permutation [ρⱼ] for stably sorting the vector [[bⱼ]] by [[ρⱼ]]←StableSort ([[bⱼ]]).

Step S105: The secret division unit 202 applies the permutation [[ρⱼ]] to the vector [[vⱼ]] by [[vⱼ′]] Apply ([[ρⱼ]], [[vⱼ]]) to calculate the vector [[vⱼ′]] of the explanatory variables obtained by stably sorting in the group after division.

Step S106: The secret division unit 202 calculates a permutation [[σⱼ′]] for stably sorting the explanatory variables in the group after division by using the following expression.

$$[ [ {σ}_{j}^{′} ] ] ← [ [ {ρ}_{j} ] ] ∘ ( [ [ {σ}_{j} ] ] ∘ {[ [ π ] ]}^{- 1} ) \qquad [ Math . 5 ]$$

Step S107: The secret division unit 202 applies the permutation [[π]] to the vector [[y]] by [[y′]]←Apply ([[π]], [[y]]) to calculate the vector of the grouped objective variables after division (that is, the vector of the objective variables obtained by further grouping the grouped objective variables) [[y′]].

Step S108: The output unit 203 outputs the vector [[y′]] of the objective variables newly grouped according to the division result, the permutation [[σⱼ′]] for stably sorting the explanatory variables newly grouped according to the division result in the group, and the vector [[vⱼ′]] obtained by stably sorting the explanatory variables newly grouped according to the division result in the group to a predetermined output destination (e.g., the storage unit 204, etc.).

As described above, the explanatory variables grouped by the secret calculation can be further grouped. Moreover, at this time, in the present example, the hidden values of y′, vⱼ′, and σⱼ′ can be calculated without sorting xⱼ. This is based on the property that, in a case where new grouping using division is performed in stable sorting using division, the configuration of a group does not change even if the order is changed in each group. That is, by rearranging the explanatory variables sorted in the group before division by stable sorting using division, it is ensured that the explanatory variables are sorted in a new group after the division due to stability of the sorting. Therefore, in the present example, when the explanatory variables grouped in secret calculation are further grouped, the calculation costs can be reduced as compared with the method of the related art.

### Specific Example

Hereinafter, a specific division example will be described. Note that, in the following, a vertical bar “|” in each expression represents a boundary between groups.

Assuming that m=2 and n=8, vectors z and wⱼ=1, 2) are as follows.

$$\begin{matrix}z = ( \begin{matrix}3 & 2 & 1 & 2 & 2 & 3 & 1 & 3\end{matrix} ) \\ {w}_{1} = ( \begin{matrix}4 & 4 & 2 & 2 & 2 & 3 & 5 & 1\end{matrix} ) \\ {w}_{2} = ( \begin{matrix}1 & 5 & 1 & 3 & 4 & 2 & 4 & 3\end{matrix} )\end{matrix} \qquad [ Math . 6 ]$$

In addition, it is assumed that the second, third, fifth, seventh, and eighth samples and the first, fourth, and sixth samples are grouped and rearranged in this order to obtain the following vectors y, x₁, and x₂.

$$\begin{matrix}y = ( \begin{matrix}2 & 1 & 2 & 1 & 3\end{matrix} \vert \begin{matrix}3 & 2 & 3\end{matrix} ) \\ {x}_{1} = ( \begin{matrix}4 & 2 & 2 & 5 & 1\end{matrix} \vert \begin{matrix}4 & 2 & 3\end{matrix} ) \\ {x}_{2} = ( \begin{matrix}5 & 1 & 4 & 4 & 3\end{matrix} \vert \begin{matrix}1 & 3 & 2\end{matrix} )\end{matrix} \qquad [ Math . 7 ]$$

At this time, the permutation σ₁, the vector v₁, the permutation σ₂, and the vector v₂ are expressed as follows.

$$\begin{matrix}{σ}_{1} = ( \begin{matrix}1 & 2 & 3 & 4 & 5 & 6 & 7 & 8 \\ 4 & 2 & 3 & 5 & 1 & 8 & 6 & 7\end{matrix} ) \\ {v}_{1} = ( \begin{matrix}1 & 2 & 2 & 4 & 5\end{matrix} \vert \begin{matrix}2 & 3 & 4\end{matrix} ) \\ {σ}_{2} = ( \begin{matrix}1 & 2 & 3 & 4 & 5 & 6 & 7 & 8 \\ 5 & 1 & 3 & 4 & 2 & 6 & 8 & 7\end{matrix} ) \\ {v}_{2} = ( \begin{matrix}1 & 3 & 4 & 4 & 5\end{matrix} \vert \begin{matrix}1 & 2 & 3\end{matrix} )\end{matrix} \qquad [ Math . 8 ]$$

A vector b representing a division result when each sample is divided into groups under a certain predetermined condition is as follows.

$$b = ( \begin{matrix}0 & 1 & 0 & 0 & 2 & 1 & 0 & 1\end{matrix} ) \qquad [ Math . 9 ]$$

Here, the vector b is assumed to be a vector indicating that the i-th sample and the j-th sample are currently included in the same group and are included in the same group after division when b[i]=b[j].

Assuming that a vector xⱼ′ is obtained by rearranging the elements of the vector xⱼ in the same arrangement as the vector y′, the following calculation results are obtained in the above-described secret division process.

$$\begin{matrix}π = ( \begin{matrix}1 & 2 & 3 & 4 & 5 & 6 & 7 & 8 \\ 1 & 5 & 2 & 3 & 8 & 6 & 4 & 7\end{matrix} ) \\ {b}_{1} = ( \begin{matrix}2 & 1 & 0 & 0 & 0\end{matrix} \vert \begin{matrix}0 & 1 & 1\end{matrix} ) \\ {ρ}_{1} = ( \begin{matrix}1 & 2 & 3 & 4 & 5 & 6 & 7 & 8 \\ 8 & 5 & 1 & 2 & 3 & 4 & 6 & 7\end{matrix} ) \\ {y}^{′} = ( \begin{matrix}2 & 2 & 1\end{matrix} \vert 2 \vert 1 \vert \begin{matrix}3 & 3\end{matrix} \vert 3 ) \\ {x}_{1}^{′} = ( \begin{matrix}4 & 2 & 5\end{matrix} \vert 2 \vert 2 \vert \begin{matrix}4 & 3\end{matrix} \vert 1 ) \\ {v}_{1}^{′} = ( \begin{matrix}2 & 4 & 5\end{matrix} \vert 2 \vert 2 \vert \begin{matrix}3 & 4\end{matrix} \vert 1 ) \\ {σ}_{1}^{′} = ( \begin{matrix}1 & 2 & 3 & 4 & 5 & 6 & 7 & 8 \\ 2 & 1 & 3 & 4 & 5 & 7 & 6 & 8\end{matrix} ) \\ {b}_{2} = ( \begin{matrix}1 & 2 & 0 & 0 & 0\end{matrix} \vert \begin{matrix}1 & 1 & 0\end{matrix} ) \\ {ρ}_{2} = ( \begin{matrix}1 & 2 & 3 & 4 & 5 & 6 & 7 & 8 \\ 5 & 8 & 1 & 2 & 3 & 6 & 7 & 4\end{matrix} ) \\ {x}_{2}^{′} = ( \begin{matrix}5 & 4 & 4\end{matrix} \vert 3 \vert 1 \vert \begin{matrix}1 & 2\end{matrix} \vert 3 ) \\ {v}_{2}^{′} = ( \begin{matrix}4 & 4 & 5\end{matrix} \vert 3 \vert 1 \vert \begin{matrix}1 & 2\end{matrix} \vert 3 ) \\ {σ}_{2}^{′} = ( \begin{matrix}1 & 2 & 3 & 4 & 5 & 6 & 7 & 8 \\ 3 & 1 & 2 & 4 & 5 & 6 & 7 & 8\end{matrix} )\end{matrix} \qquad [ Math . 10 ]$$

### Effects

In a case where the decision tree is learned by secret calculation, it is necessary to divide the grouped training data and create training data aligned by new grouping, and to this end, it is necessary in the related art to sort the explanatory variables in ascending order in each new group. On the contrary, according to the present embodiment, it is not necessary to sort the explanatory variables in ascending order in each new group, and sorting of division results, application of a permutation, synthesis of permutations, and calculation of a reverse permutation are better to be performed, and as a result, the calculation costs are reduced.

Note that, although the secret division process in which data grouped by secret calculation are further grouped on the assumption that the decision tree is learned by the secret calculation has been described in the present embodiment, the secret division device 10 according to the present embodiment may execute a process of learning the decision tree by repeating the above-described secret division process. Furthermore, the secret division device 10 according to the present embodiment may make use of a learned decision tree to execute processes such as various data analysis, data classification, and device control based on the analysis or classification result (for example, control of stopping of the device based on an abnormality detection result, etc.).

The present invention is not limited to the foregoing specifically disclosed embodiment, and various modifications and changes, combinations with known technologies, and the like can be made without departing from the scope of the claims.

### REFERENCE SIGNS LIST

10 Secret division device
101 Input device
102 Display device
103 External I/F
103a Recording medium
104 Communication I/F
105 Processor
106 Memory device
107 Bus
201 Input unit
202 Secret division unit
203 Output unit
204 Storage unit

1. A secure grouping apparatus configured to be given training data including a plurality of samples having m explanatory variables as a hidden value of an objective variable vector z having a value of an objective variable of each sample as an element and an explanatory variable vector wⱼ (j∈[1, m]) having a value of a j-th explanatory variable of each sample as an element, group the samples included in the training data into groups, and execute grouping to arrange samples in a same group to be continuous in secure calculation, the secure grouping apparatus comprising:
a memory; and
a processor configured to execute:
inputting a hidden value of an objective variable vector y of the grouped training data, a hidden value of a permutation σⱼ for stably sorting a j-th explanatory variable vector of the grouped training data in a group, a hidden value of an explanatory variable vector vⱼ obtained by stably sorting the j-th explanatory variable vector of the grouped training data in the group, and a hidden value of a grouping result vector b representing a grouping result when the training data is grouped into groups under a predetermined condition; and
calculating, in secure calculation, a hidden value of an objective variable vector y′ of the training data newly grouped according to a grouping result represented by the grouping result vector, a hidden value of a permutation σⱼ′ for stably sorting the j-th explanatory variable vector of the training data newly grouped according to the grouping result in a group, and a hidden value of an explanatory variable vector vⱼ′ obtained by stably sorting the j-th explanatory variable vector of the training data newly grouped according to the grouping result in a group.

2. The secure grouping apparatus according to claim 1, wherein
the calculating includes
calculating a hidden value of a permutation π for stably sorting elements of the grouping result vector b,
calculating a hidden value of a grouping result vector bⱼ obtained by rearranging the elements of the grouping result vector b in the permutation σⱼ,
calculating a hidden value of a permutation ρⱼ for stably sorting the elements of the grouping result vector bⱼ,
calculating a hidden value of the explanatory variable vector vⱼ′ by rearranging elements of the explanatory variable vector vⱼ in the permutation ρⱼ,
calculating a hidden value of the permutation σⱼ′ by synthesizing the permutation ρⱼ, the permutation σⱼ, and an inverse permutation of the permutation π, and
calculating a hidden value of the objective variable vector y′ by rearranging elements of the objective variable vector y in the permutation π.

3. The secure grouping apparatus according to claim 1, wherein
the training data is data for learning a decision tree, and
the secure grouping apparatus learns the decision tree by repeating input by the input unit and calculation at the calculating.

4. A secure grouping method performed by a secure grouping apparatus configured to be given training data including a plurality of samples having m explanatory variables as a hidden value of an objective variable vector z having a value of an objective variable of each sample as an element and an explanatory variable vector wⱼ (j∈[1, m]) having a value of a j-th explanatory variable of each sample as an element, group the samples included in the training data into groups, and execute grouping to arrange samples in the same group to be continuous in secure calculation, the secure grouping method comprising:
inputting a hidden value of an objective variable vector y of the grouped training data, a hidden value of a permutation σⱼ for stably sorting a j-th explanatory variable vector of the grouped training data in a group, a hidden value of an explanatory variable vector vⱼ obtained by stably sorting the j-th explanatory variable vector of the grouped training data in the group, and a hidden value of a grouping result vector b representing a grouping result when the training data is grouped into groups under a predetermined condition; and
calculating, a hidden value of an objective variable vector y′ of the training data newly grouped according to a grouping result represented by the grouping result vector, a hidden value of a permutation σⱼ′ for stably sorting the j-th explanatory variable vector of the training data newly grouped according to the grouping result in a group, and a hidden value of an explanatory variable vector vⱼ′ obtained by stably sorting the j-th explanatory variable vector of the training data newly grouped according to the grouping result in a group.

5. (canceled)

6. A non-transitory computer-readable recording medium having computer-readable instructions stored thereon, which when executed, cause a computer including a memory and a processor to execute the method according to claim 4.
